(19) United States
(12) Patent Application Publication
(10) Pub. No.: US 2015/0087166 A1
(43) Pub. Date: Mar. 26, 2015

(54) NETWORK ADAPTER CARD HAVING TWO SWITCHABLE NETWORK CONNECTORS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/144,609

(22) Filed: Dec. 31, 2013

(30) Foreign Application Priority Data
Sep. 23, 2013 (CN) 2013104341072

(51) Int. Cl. H01R 12/72; H01R 24/64

(52) U.S. Cl. CPC H01R 12/722; H01R 24/64; H01R 2103/00
USPC 439/78

(57) ABSTRACT

A network adapter card includes a main card, a first secondary card, and a second secondary card. The main card includes a PCIe male connector, an adapter female connector, and a first chip group connected between the PCIe male connector and the adapter female connector. The first chip group converts a PCIe signal to a SFI signal. The first secondary card includes a first adapter male connector and a SFP+ female connector connected to the first adapter male connector. The second secondary card includes a second adapter male connector, a RJ-45 female connector, and a second chip group connected between the second adapter male connector and the RJ-45 female connector. The second chip group converts the SFI signal to a RJ-45 signal. The first adapter male connector or the second adapter male connector is plugged to be connected to the adapter female connector.

### BACKGROUND

1. Technical Field

The present disclosure relates to network adapter cards, and particularly to a network adapter card having a peripheral component interface express (PCIe) male connector selectively connected to a small form factor pluggable (SFP+) female connector or a RJ-45 female connector.

2. Description of Related Art

Network adapter cards include a PCIe male connector and a network female connector. In use, the network adapter card can couple a network cable having a network male connector engaged with the network female connector to a motherboard having a PCIe female computer engaged with the PCIe female connector. If a type of the network female connector is not corresponding to a type of the network male connector, the network adapter card will not be connected between the PCIe female connector and the network male connector, which decreases a versatility of the network adapter card.

Therefore, it is desirable to provide a network adapter card that can overcome the limitations described.

### BRIEF DESCRIPTION OF THE DRAWINGS

FIG. 1 is a functional block diagram of a network adapter card in accordance with an exemplary embodiment.

FIG. 2 is a functional block diagram of a main card connected to a first secondary card of FIG. 1.

FIG. 3 is a functional block diagram of a main card connected to a second secondary card of FIG. 1.

### DETAILED DESCRIPTION

Embodiments of the disclosure will be described with reference to the drawings.

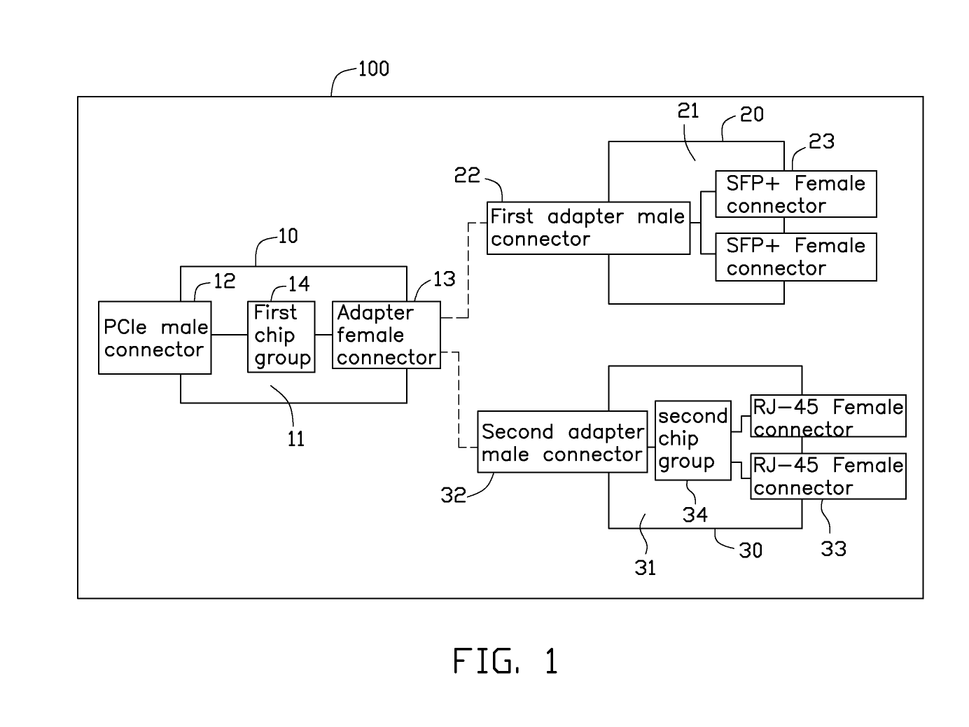

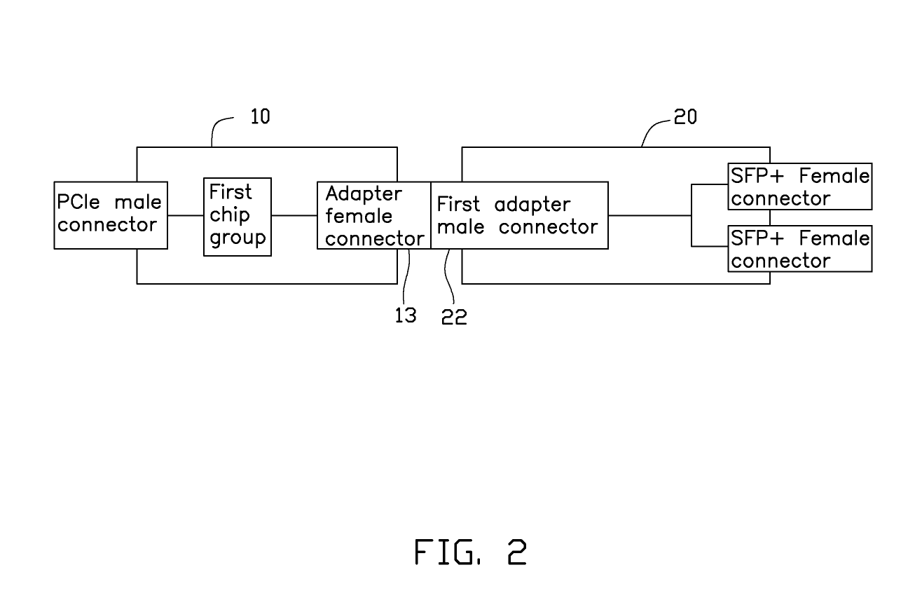

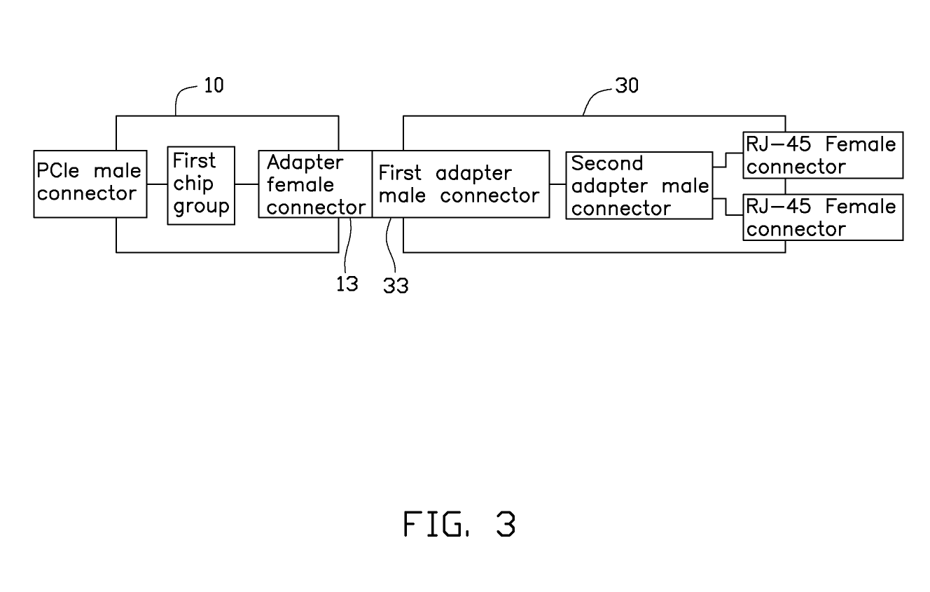

FIGS. 1-3 show a network adapter card 100, according to an exemplary embodiment. The network adapter card 100 is used to connect a PCIe female connector on a motherboard (not shown) to a network male connector (not shown) on a network cable. The network adapter card 100 includes a main card 10, a first secondary card 20, and a second secondary card 30. In the embodiment, the network adapter card 100 is used in an electronic device (not shown).

The main card 10 includes a main circuit board 11, a PCIe male connector 12, an adapter female connector 13, and a first chip group 14. The PCIe male connector 12, the adapter female connector 13, and the first chip group 14 are mounted on the main circuit board 11. The first chip group 14 is connected between the PCIe male connector 12 and the adapter female connector 13. The first chip group 14 is configured for converting a PCIe signal received from the PCIe male connector 12 to a SFP+ high speed serial electrical interface (SFI) signal. The PCIe signal is converted to the SFI signal in a network layer by the first chip group 14.

In the embodiment, the PCIe male connector 12 has a number of pins corresponding to a PCIe female connector (not shown). The adapter female connector 13 is a standard SFI connector.

The first secondary card 20 includes a first secondary circuit board 21, a first adapter male connector 22, and a SFP+ female connector 23. The first adapter male connector 22 and the SFP+ female connector 23 are mounted on the first secondary circuit board 21. The first adapter male connector 22 is connected to the SFP+ female connector 23. The SFI signal received by the first adapter male connector 22 outputs from the SFP+ female connector 23 as a SFP signal. A format of the SFI signal is the same as a format of the SFP signal.

In the embodiment, the first secondary card 20 includes two SFP+ female connectors 23. The SFP+ female connector 23 has a number of pins corresponding to an optical fiber connector (not shown). The first adapter male connector 22 is a standard SFI connector.

The second secondary card 30 includes a second secondary circuit board 31, a second adapter male connector 32, a RJ-45 female connector 33, and a second chip group 34. The second adapter male connector 32, the RJ-45 female connector 33, and the second chip group 34 are mounted on the second secondary circuit board 31. The second chip group 34 is connected between the second adapter male connector 32 and the RJ-45 female connector 33. The second chip group 34 is configured for converting the SFI signal received from the second adapter male connector 32 to a RJ-45 signal. The SFI signal is converted to the RJ-45 signal in a physical layer by the second chip group 34.

In the embodiment, the second secondary card 30 includes two RJ-45 female connectors 33. The RJ-45 female connector 33 has a number of pins corresponding to an optical fiber connector (not shown). The second adapter male connector 32 has the same structure with the first adapter connector 22, and is a standard SFI connector.

In use, the main card 10 is connected to the PCIe female connector of a main board. When the electronic device is used in an area just having optical fibers, the first secondary card 20 is connected to the main card 10 via the first adapter male connector 22 plugged into the adapter female connector 13. The network male connector is plugged into the SFP+ female connectors 23. Therefore, the electronic device is connected to the optical fibers.

When the electronic device is used in an area just having twisted pairs, the second secondary card 30 is connected to the main card 10 via the second adapter male connector 32 plugged into the adapter female connector 13. The network male connector is plugged into the RJ-45 female connectors 33. Therefore, the electronic device is connected to the twisted pairs.

In the embodiment, the first secondary card 20 or the second secondary card 30 can be plugged to be connected to the main card 10, therefore the network adapter card 100 has the SFP+ female connectors 23 or the RJ-45 female connectors 33 connected to the PCIe female connector. Therefore, the network adapter card 100 is able to selectively connect to the optical fibers or the twisted pairs.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A network adapter card, comprising:
a main card comprising a peripheral component interface express (PCIe) male connector, an adapter female connector, and a first chip group connected between the PCIe male connector and the adapter female connector, the first chip group converting a PCIe signal received from the PCIe male connector to a small form factor pluggable (SFP+) high speed serial electrical interface (SFI) signal;
a first secondary card comprising a first adapter male connector and a SFP+ female connector connected to the first adapter male connector; and
a second secondary card comprising a second adapter male connector, a RJ-45 female connector, and a second chip group connected between the second adapter male connector and the RJ-45 female connector; the second chip group converting the SFI signal received from the second adapter male connector to a RJ-45 signal;
wherein the first adapter male connector or the second adapter male connector is pluggable connected to the adapter female connector.

2. The network adapter card of claim 1, wherein the first chip group receives the PCIe signal from the PCIe male connector.

3. The network adapter card of claim 1, wherein the SFI signal received by the first adapter male connector outputs from the SFP+ female connector as a SFP signal, a format of the SFI signal is the same as a format of the SFP signal.

4. The network adapter card of claim 1, wherein the PCIe signal is converted to the SFI signal in a network layer by the first chip group.

5. The network adapter card of claim 1, wherein the SFI signal is converted to the RJ-45 signal in a physical layer by the second chip group.

6. The network adapter card of claim 1, wherein the second adapter male connector has the same structure as the first adapter connector, and is a standard SFI connector.

7. The network adapter card of claim 1, wherein the main card comprises a main circuit board, the PCIe male connector, the adapter female connector, and the first chip group are mounted on the main circuit board.

8. The network adapter card of claim 1, wherein the first secondary card comprises a first secondary circuit board, the first adapter male connector and the SFP+ female connector are mounted on the first secondary circuit board.

9. The network adapter card of claim 1, wherein the second secondary card comprises a second secondary circuit board, the second adapter male connector, the RJ-45 female connector, and the second chip group are mounted on the second secondary circuit board.
